(19) United States
(12) Patent Application Publication
(10) Pub. No.: US 2005/0002389 A1
(43) Pub. Date: Jan. 6, 2005

(54) Method, system, and program for processing a packet to transmit on a network in a host system including a plurality of network adaptors

(75) Inventors: Anand Venkatanarayan, Bangalore (IN); Aravind Manohar, Bangalore (IN)

Correspondence Address: KONRAD RAYNES VICTOR & MANN LLP, Suite 210, 315 S. Beverly Drive, Beverly Hills, CA, 90212, US

(73) Assignee: Intel Corporation

(21) Appl. No.: 10/612,695

(22) Filed: Jul. 2, 2003

(51) Int. Cl. H04L 12/56

(52) U.S. Cl. 370/389

(57) ABSTRACT

Provided are a method, system, and program for processing a packet to transmit on a network in a host system including a plurality of network adaptors. A packet is received at a first network adaptor. The first network adaptor performs load balancing operations to select one network adaptor to transmit the received packet. If the determined network adaptor is a second network adaptor, then the received packet is forwarded to the second network adaptor.

### BACKGROUND OF THE INVENTION

1. Field of the Invention

The present invention relates to a method, system, and program for processing a packet to transmit on a network in a host system Including a plurality of network adaptors

2. Description of the Related Art

A host computer may have multiple network cards to connect the system to a network. In current systems, the host would include a network device driver, which is a software program that executes to interface between the host operating system and the network cards. For hosts including multiple processors, the device driver would select one of the network cards to transmit a packet. The device driver executing in the host typically executes a load balancing algorithm to select a particular network card to transmit the packet. Such load balancing algorithms require a significant amount of host central processing unit (CPU) resources and cycles to execute. The burdens on the host CPU increase as the number of adaptors increase and as the number of transactions being handled by the device driver increases. The CPU resources required to perform load balancing operations can range from 5% to 50% of the CPU capacity, depending on the CPU processing speed, the number of adaptors, and amount of transmission activity.

Notwithstanding, there is a continued need in the art to improve the performance of the device driver and minimize device driver processing burdens on the host processor.

### BRIEF DESCRIPTION OF THE DRAWINGS

Referring now to the drawings in which like reference numbers represent corresponding parts throughout:

FIG. 1 illustrates a computing environment in which embodiments of the invention are implemented;

FIG. 2 illustrates a operations to select a network adaptor in accordance with embodiments of the invention; and

FIG. 3 illustrates a computer architecture that may be used with the described embodiments.

### DETAILED DESCRIPTION OF THE EMBODIMENTS

In the following description, reference is made to the accompanying drawings which form a part hereof and which illustrate several embodiments of the present invention. It is understood that other embodiments may be utilized and structural and operational changes may be made without departing from the scope of the present invention.

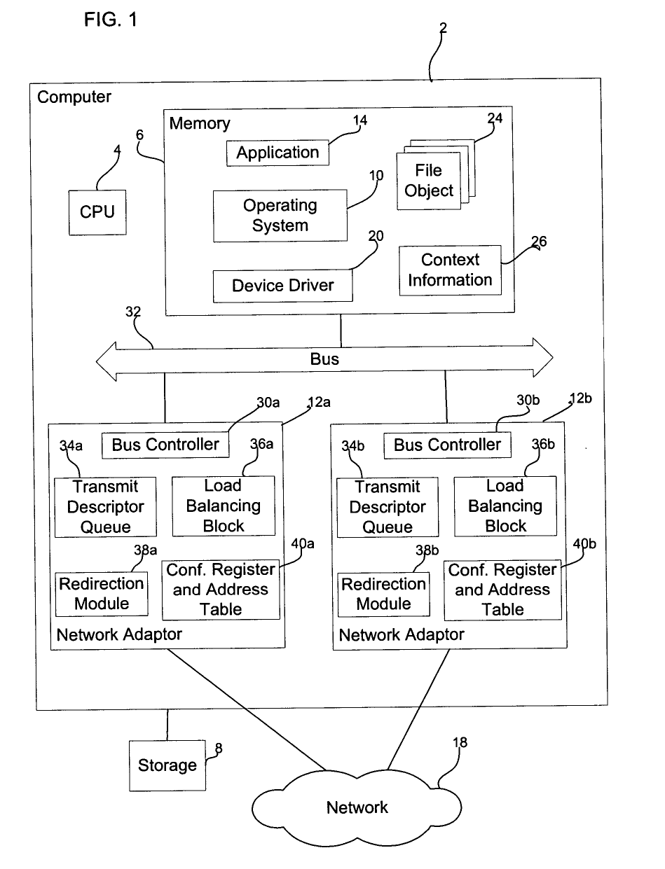

FIG. 1 illustrates a computing environment in which embodiments of the invention may be implemented. A host computer 2 includes one or more central processing units (CPU) 4, a volatile memory 6, non-volatile storage 8, an operating system 10, and multiple network adaptors 12a, 12b. Although only two network adaptors are shown, the host 2 may include more than two network adaptors. An application program 14 further executes in memory 6 and is capable of transmitting and receiving packets from a remote computer. The host 2 may comprise any computing device known in the art, such as a mainframe, server, personal computer, workstation, laptop, handheld computer, telephony device, network appliance, virtualization device, storage controller, etc. Any CPU 4 and operating system 10 known in the art may be used. Programs and data in memory 6 may be swapped into storage 8 as part of memory management operations.

The network cards 12a, 12b are capable of transmitting and receiving packets of data over network 18, which may comprise a Local Area Network (LAN), the Internet, a Wide Area Network (WAN), Storage Area Network (SAN), wireless network (Wireless Fidelity), etc. A device driver 20 executes in memory 6 and includes network adaptor 12a, 12b specific commands to communicate with the network adaptors 12a, 12b and interface between the operating system 10 and the network adaptors 12a, 12b. The network adaptors 12a, 12b or device driver 20 would implement logic to process the packets, such as a transport protocol layer to process the content of messages included in the packets that are wrapped in a transport layer, such as Transmission Control Protocol (TCP) and/or Internet Protocol (IP), the Internet Small Computer System Interface (iSCSI), Fibre Channel, SCSI, parallel SCSI transport, or any other transport layer protocol known in the art. The transport protocol layer would unpack the payload from the received TCP/IP packet and transfer the data to the device driver 20 to return to the application 14. Further, an application 14 transmitting data would transmit the data to the device driver 20, which would then send the data to the transport protocol layer to package in a TCP/IP packet before transmitting over the network 18.

The network adaptor 12a, 12b may further include a network protocol layer that implements the physical communication layer to send and receive network packets to and from remote devices over a network 18. In certain embodiments, the network adaptor 12a, 12b network protocol layer (not shown) may implement the Ethernet protocol, token ring protocol, Fibre Channel protocol, Infiniband, Serial Advanced Technology Attachment (SATA), parallel SCSI, serial attached SCSI cable, etc., or any other network communication protocol known in the art.

The network adaptors 12a, 12b include various components implemented in the hardware of the adaptors. A bus controller 30a, 30b enables the network adaptor 12a, 12b to communicate on a computer bus 32, which may comprise any bus interface known in the art, such as a Peripheral Component Interconnect (PCI) bus, Small Computer System Interface (SCSI), Serial ATA, etc. A transmit descriptor queue 34a, 34b receives and queues packets transmitted to the adaptor 12a, 12b over the bus 32. A load balancing block 36a, 36b includes logic to implement a load balancing algorithm to select one of the plurality of network adaptors 12a, 12b to transmit the received packet. The load balancing algorithm may use any load balancing technique known in the art, such as round robin, etc. The load balancing algorithm implemented in the load balancing blocks 36a, 36b may determine the relative load at each of the network adaptors 12a, 12b and then select one network adaptor having the lightest load. Alternatively, the load balancing algorithm may select a network adaptor 12a, 12b to handle a packet based on the network address, e.g., IP address, to which the packet is directed. A hash table may be used to associate an IP address with a network adaptor 12a, 12b to transmit that packet. In such hash table implementations, the load balancing block 36a, 36b would hash the target IP address of the packet to select a network adaptor to transmit that packet. In certain implementations, only the network adaptor 12a, 12b operating as the primary adaptor would perform the load balancing operations.

The network adaptors 12a, 12b further include a redirection module 38a, 38b that interfaces with the bus controller 30a, 30b to redirect a packet in the transmit descriptor queue 34a, 34b to another network adaptor 12a, 12b if the load balancing block 36a, 36b determines that another network adaptor 12a, 12b should handle the transmission of the received packet. The redirection module 38a, 38b is only enabled on the primary network adaptor 12a, 12b. The configuration register and address table 40a, 40b provide state information used to indicate the state of the network card. The configuration register 40a, 40b would indicate whether a network adaptor 12a, 12b is a primary or secondary adaptor. The address table 40a, 40b includes the bus addresses of other network adaptors 12a, 12b coupled to the bus 32.

The network adaptors 12a, 12b may include additional hardware logic to perform additional operations to process received packets from the host 2 or the network 18. Further, the network adaptors 12a, 12b may implement a transport layer offload engine (TOE) to implement the transport protocol layer in the network adaptor as opposed to the host device driver 30 to further reduce host processing burdens. Alternatively, the transport layer may be implemented in the device driver 20.

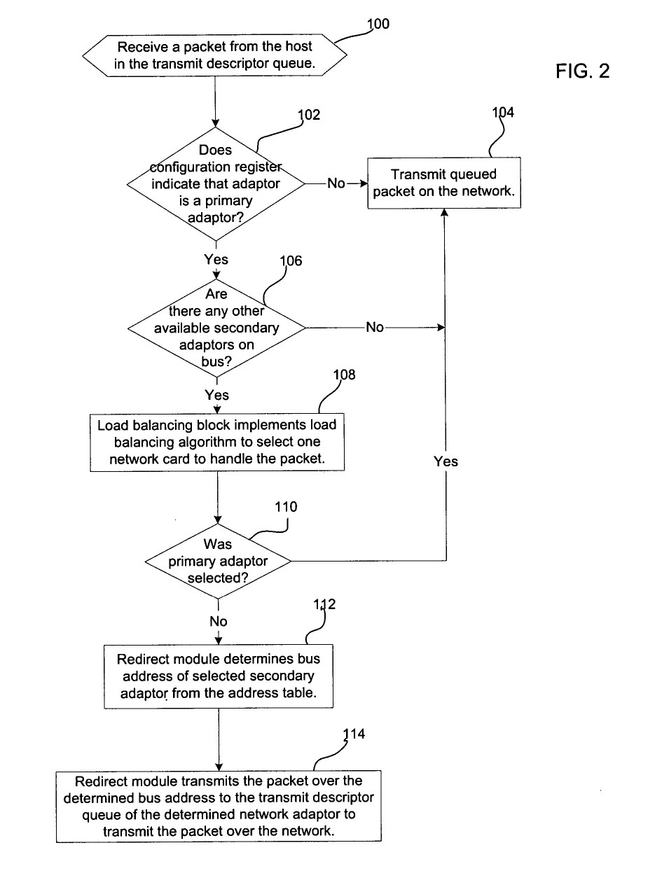

FIG. 2 illustrates operations performed in the components of the network adaptors 12a, 12b. Upon receiving (at block 100) a packet from the host device driver 20 in the transmit descriptor queue 34a, 34b, if (at block 102) the configuration register 40a, 40b indicates that the network adaptor 12a, 12b is a secondary adaptor, then the queued packet is transmitted (at block 104) to the network 18 from the adaptor 12a, 12b receiving the packet, either from a host or primary adaptor. If (at block 102) the configuration register 40a, 40b indicates that the network adaptor 12a, 12b is a primary adaptor and if (at block 106) there is at least one secondary network adaptor available on the bus 32, then the load balancing block 36a, 36b performs (at block 108) a load balancing operation to select one network adaptor 12a, 12b, either itself (the primary) or one of the secondaries, to transmit the packet. If (at block 106) there are no active secondary adaptors, then control proceeds to block 104 to transmit the packet. If (at block 110) the load balancing algorithm in block 36a, 36b selected the primary network adaptor 12a, 12b, then the primary network adaptor 12a, 12b transmits the packet in the transmit descriptor queue 34a, 34b to the network 18. Otherwise, if (at block 110) a secondary adaptor was selected, the redirection module 38a, 38b determines (at block 112) from the address table 40a, 40b the bus address of the selected secondary adaptor and transmits (at block 114) the packet in the transmit descriptor queue 34a, 34b over the bus 32 to the determined bus address of the selected secondary network adaptor 12a, 12b. The secondary network adaptor 12a, 12b receiving the packet would then perform the operations in FIG. 2 to process the received packet.

The device driver 20 may designate as a default one network adaptor 12a, 12b as the primary adaptor and always send packets to the designated primary adaptor. In this way, the device driver 20 does not perform any load balancing or selection weighing operations, but just sends the packet to the designated primary network adaptor. In the event of a failure of the primary adaptor, the device driver 20 could perform a failover operation to designate one surviving network adaptor as the primary adaptor.

The described implementations substantially reduce host CPU utilization by offloading the load balancing operations from the host device driver to the network adaptor hardware by having the network adaptors perform teaming operations to transfer packets to the network adaptor most suitable to transmit a packet according to load balancing algorithms implemented in the network adaptor logic. Further, the described embodiments reduce processor overhead with a nominal increase in I/O overhead to transfer packets over the bus 32 between network adaptors. I/O overhead is nominal because only a portion of the packets are transferred over the bus to a secondary adaptor if certain load balancing conditions are satisfied.

### Additional Embodiment Details

The described techniques for processing packets of data may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Programmable Gate Array (PGA), Application Specific Integrated Circuit (ASIC), etc.) or a computer readable medium, such as magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code in which preferred embodiments are implemented may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Thus, the “article of manufacture” may comprise the medium in which the code is embodied. Additionally, the “article of manufacture” may comprise a combination of hardware and software components in which the code is embodied, processed, and executed. Of course, those skilled in the art will recognize that many modifications may be made to this configuration without departing from the scope of the present invention, and that the article of manufacture may comprise any information bearing medium known in the art.

In the described embodiments, the load balancing logic was implemented in network adaptor hardware. In additional implementations, the network adaptor may include a processor and memory to execute instructions loaded into memory to perform the load balancing operations, as opposed to implementing the load balancing logic in hardware, such as an Application Specific Integrated Circuit (ASIC).

In the described implementations, the secondary network adaptors upon receiving a packet would transmit such packet and not perform any further load balancing operations. In further implementations, the secondary network packet receiving a redirected packet from a primary network adaptor may perform additional load balancing operations to determine whether to transmit or redirect the packet to another network adaptor.

The network adaptor may be implemented in a network adaptor card inserted in a slot of the host 2, such as a PCI card. Alternatively, the network adaptor may comprise integrated circuit components mounted on the host 2 motherboard.

In certain implementations, the device driver and network adaptor embodiments may be included in a computer system including a storage controller, such as a SCSI, Integrated Drive Electronics (IDE), Redundant Array of Independent Disk (RAID), etc., controller, that manages access to a non-volatile storage device, such as a magnetic disk drive, tape media, optical disk, etc. In alternative implementations, the network adaptor embodiments may be included in a system that does not include a storage controller, such as certain hubs and switches.

In certain implementations, the network adaptor may be configured to transmit data across a cable connected to a port on the network adaptor. Alternatively, the network adaptor embodiments may be configured to transmit data over a wireless network or connection, such as wireless LAN, Bluetooth, etc.

In the described implementations, the device driver 20 did not perform load balancing operations and load balancing operations were performed in the primary network adaptors 12a, 12b. In alternative implementations, the device driver 20 may perform certain load balancing algorithms to select one network adaptor, and then the selected network adaptor may perform further, more intensive, load balancing operations to improve the capability of selecting an optimal network adaptor to handle the request.

The illustrated logic of FIG. 2 shows certain events occurring in a certain order. In alternative embodiments, certain operations may be performed in a different order, modified or removed. Morever, steps may be added to the above described logic and still conform to the described embodiments. Further, operations described herein may occur sequentially or certain operations may be processed in parallel. Yet further, operations may be performed by a single processing unit or by distributed processing units.

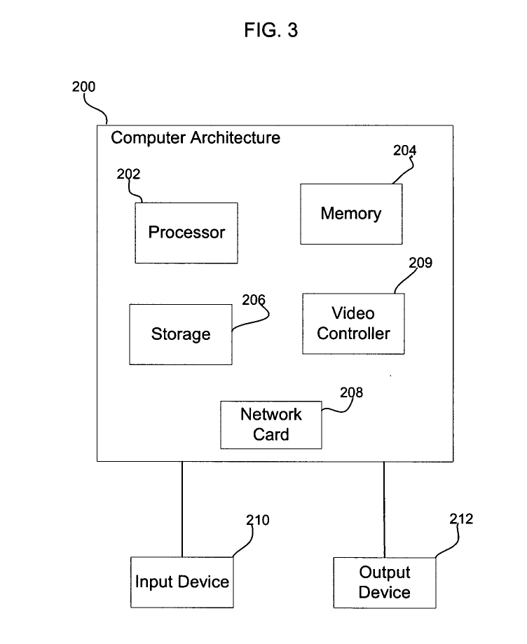

FIG. 3 illustrates one implementation of a computer architecture 200 of the network components, such as the hosts shown in FIG. 1. The architecture 200 may include a processor 202 (e.g., a microprocessor), a memory 204 (e.g., a volatile memory device), and storage 206 (e.g., a non-volatile storage, such as magnetic disk drives, optical disk drives, a tape drive, etc.). The storage 206 may comprise an internal storage device or an attached or network accessible storage. Programs in the storage 206 are loaded into the memory 204 and executed by the processor 202 in a manner known in the art. The architecture further includes a network card 208 to enable communication with a network, such as an Ethernet, a Fibre Channel Arbitrated Loop, etc. Further, the architecture may, in certain embodiments, include a video controller 209 to render information on a display monitor, where the video controller 209 may be implemented on a video card or integrated on integrated circuit components mounted on the motherboard. As discussed, certain of the network devices may have multiple network cards. An input device 310 is used to provide user input to the processor 202, and may include a keyboard, mouse, pen-stylus, microphone, touch sensitive display screen, or any other activation or input mechanism known in the art. An output device 212 is capable of rendering information transmitted from the processor 202, or other component, such as a display monitor, printer, storage, etc.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

1. A method for processing a packet to transmit on a network in a host system including a plurality of network adaptors, comprising:
receiving at a first network adaptor a packet;
performing, within the first network adaptor, load balancing operations to select one network adaptor to transmit the received packet; and
if the determined network adaptor is a second network adaptor, then forwarding, with the first network adaptor, the received packet to the second network adaptor.

2. The method of claim 1, further comprising:
determining, with the first network adaptor, whether the first network adaptor is a primary network adaptor or a secondary network adaptor; and
transmitting, with the first network adaptor, the received packet over a network if the first network adaptor is the secondary network adaptor, wherein the first network adaptor performs the load balancing operations if the first network adaptor is the primary network adaptor.

3. The method of claim 2, wherein the load balancing operations are only performed in the primary network adaptor.

4. The method of claim 1, wherein performing the load balancing operations comprises:
determining one network adaptor as a function of a destination network address to which the received packet is to be transmitted over the network.

5. The method of claim 4, wherein the network address comprises one of an Internet Protocol address and Fibre Channel address.

6. The method of claim 5, wherein determining one network adaptor as the function of the target network address comprises using a hash algorithm to select one network adaptor based on the target network address.

7. The method of claim 1, wherein performing the load balancing operations comprises:
determining one network adaptor based on a relative load of each of the network adaptors.

8. A method implemented in a device driver executing in a host system for processing a packet to transmit on a network, wherein the host includes a plurality of network adaptors, and wherein the device driver performs:
receiving a packet; and
initiating transmission of the packet to one network adaptor designated as a primary network adaptor, wherein the primary network adaptor is capable of performing load balancing operations to determine one network adaptor to transmit the received packet and redirect the packet to another network adaptor to transmit the packet.

9. The method of claim 8, wherein the device driver does not perform load balancing operations when selecting one of the plurality of network adaptors to receive the packet.

10. The method of claim 8, wherein the device driver further performs:
detecting a failure of one network adaptor designated as the primary network adaptor;
determining an available network adaptor to function as the primary network adaptor, wherein subsequently received packets are transmitted to the determined network adaptor;
configuring a register within the determined network adaptor to cause the determined network adaptor to operate as the primary network adaptor and perform load balancing operations.

11. A method implemented in a device driver executing in a host system for processing a packet to transmit on a network, wherein the host includes a plurality of network adaptors, and wherein the device driver performs:
receiving a packet; and
initiating transmission of the packet to one network adaptor designated as a primary network adaptor, wherein the primary network adaptor is capable of performing load balancing operations to determine one network adaptor to transmit the received packet and redirect the packet to another network adaptor to transmit the packet.

12. The method of claim 11, wherein the device driver does not perform load balancing operations when selecting one of the plurality of network adaptors to receive the packet.

13. The method of claim 11, wherein the device driver further performs:
detecting a failure of one network adaptor designated as the primary network adaptor;
determining an available network adaptor to function as the primary network adaptor, wherein subsequently received packets are transmitted to the determined network adaptor; and
configuring a register within the determined network adaptor to cause the determined network adaptor to operate as the primary network adaptor and perform load balancing operations.

14. A network adaptor in a host system in communication with an external network adaptor, comprising:
an interface to interface with at least one external network adaptor;
control logic to cause the network adaptor to perform operations, the operations comprising:
(i) receive a packet;
(ii) perform load balancing operations to select one network adaptor to transmit the received packet; and
(iii) if the determined network adaptor is one external network adaptor, then forwarding the received packet to the external network adaptor.

15. The network adaptor of claim 14, wherein the operations caused by the control logic further comprise:
determine whether the network adaptor is a primary network adaptor or a secondary network adaptor; and
initiating transmission of the received packet over a network if the network adaptor is the secondary network adaptor, wherein the load balancing operations are performed if the network adaptor is the primary network adaptor.

16. The network adaptor of claim 14, wherein the load balancing operations comprise:
determine one network adaptor as a function of a destination network address to which the received packet is to be transmitted over the network.

17. The network adaptor of claim 16, wherein to determine one network adaptor as the function of the target network address comprises using a hash algorithm to select one network adaptor based on the target network address.

18. The network adaptor of claim 14, wherein the load balancing operations comprise:
determine one network adaptor based on a relative load of each of the network adaptors.

19. The method of claim 14, wherein the packets are coded using the Internet Protocol (IP).

20. A system coupled to a network and data storage, comprising:
a processor;
a storage controller managing Input/Output (I/O) access to the data storage;
a plurality of network adaptors capable of transmitting and receiving data on the network;
a device driver, executed by the processor, to perform operations, the operations comprising:
(i) receive a packet; and
(ii) initiate transmission of the packet to one network adaptor designated as a primary network adaptor, wherein the primary network adaptor is capable of performing load balancing operations to select one network adaptor to transmit the received packet and forward the packet to another network adaptor to transmit the packet.

21. The system of claim 20, wherein the device driver does not perform load balancing operations when selecting one of the plurality of network adaptors to receive the packet.

22. The system of claim 20, wherein the device driver operations further comprise:
detect a failure of one network adaptor designated as the primary network adaptor;
determine an available network adaptor to function as the primary network adaptor, wherein subsequently received packets are transmitted to the determined network adaptor; and
configure a register within the determined network adaptor to cause the determined network adaptor to operate as the primary network adaptor and perform load balancing operations.

23. The system of claim 20, wherein the data storage comprises a magnetic storage media.

24. The system of claim 23, wherein the first network adaptor performs operations comprising:
determine whether the first network adaptor is a primary network adaptor or a secondary network adaptor; and
initiate transmission of the received packet over a network if the first network adaptor is the secondary network adaptor, wherein the first network adaptor performs the load balancing operations if the first network adaptor is the primary network adaptor.

25. An article of manufacture for processing a packet to transmit on a network in a host system including a plurality of network adaptors, wherein the article of manufacture causes operations to be performed, the operations comprising:
receiving at a first network adaptor a packet;
performing, within the first network adaptor, load balancing operations to select one network adaptor to transmit the received packet; and
if the determined network adaptor is a second network adaptor, then forwarding, with the first network adaptor, the received packet to the second network adaptor.

26. The article of manufacture of claim 25, wherein the operations further comprise:
determining, with the first network adaptor, whether the first network adaptor is a primary network adaptor or a secondary network adaptor; and
initiating transmission, with the first network adaptor, the received packet over a network if the first network adaptor is the secondary network adaptor, wherein the first network adaptor performs the load balancing operations if the first network adaptor is the primary network adaptor.

27. The article of manufacture of claim 26, wherein the load balancing operations are only performed in the primary network adaptor.

28. The article of manufacture of claim 25, wherein performing the load balancing operations comprises:
determining one network adaptor as a function of a destination network address to which the received packet is to be transmitted over the network.

29. The article of manufacture of claim 27, wherein determining one network adaptor as the function of the target network address comprises using a hash algorithm to select one network adaptor based on the target network address.

30. The article of manufacture of claim 24, wherein performing the load balancing operations comprises:
determining one network adaptor based on a relative load of each of the network adaptors.

31. An article of manufacture for processing a packet to transmit on a network, in a host that includes a plurality of network adaptors, wherein the article of manufacture causes operations to be performed, the operations comprising:
receiving a packet; and
initiating transmission of the packet to one network adaptor designated as a primary network adaptor, wherein the primary network adaptor is capable of performing load balancing operations to determine one network adaptor to transmit the received packet and redirect the packet to another network adaptor to transmit the packet.

32. The article of manufacture of claim 31, wherein the load balancing operations are not performed when selecting one of the plurality of network adaptors to receive the packet.

33. The article of manufacture of claim 31, wherein the operations further comprise:
detecting a failure of one network adaptor designated as the primary network adaptor;
determining an available network adaptor to function as the primary network adaptor, wherein subsequently received packets are transmitted to the determined network adaptor; and
configuring a register within the determined network adaptor to cause the determined network adaptor to operate as the primary network adaptor and perform load balancing operations.
